(19) United States
(12) Patent Application Publication
(10) Pub. No.: US 2003/0098667 A1
(43) Pub. Date: May 29, 2003

(54) Linear forced drive carrier auxiliary or damping system

(76) Inventor: Tai-Her Yang, Si-Hu Town (TW)

Correspondence Address: BACON & THOMAS, PLLC, 625 SLATERS LANE, FOURTH FLOOR, ALEXANDRIA, VA, 22314

(21) Appl. No.: 09/991,955

(22) Filed: Nov. 26, 2001

(51) Int. Cl. H02P 1/24; H02P 1/42; H02P 3/18; H02P 5/28; H02P 7/36

(52) U.S. Cl. 318/727

(57) ABSTRACT

An auxiliary or damping system adapted to a linear forced drive carrier includes a linear forced drive detection device to detect in one-way or two-way direction and strength of externally force applied and to transmit signals to motor drive control device, then to control carrier power source to drive the motor for executing drive in relative direction to produce positive torque for auxiliary drive, or inverse damping of inverse torque, or to produce auxiliary or damping function by controlling clutch or braking damper of a controllable transmission gear to achieve auxiliary drive or damping function.

### BACKGROUND OF THE INVENTION

(a) Field of the Invention

The present invention relates to an auxiliary or damping system for a linear forced drive carrier subject to manually linear push/pull, and more particularly, to one adapted to a linear forced drive carrier; the carrier may be of a single unit or multiple units linear forced drive carrier drawn in series, or multiple units of land carrier drawn in series with each unit provided with individual power system and a unit at either end as an active drive; or multiple units of surface or subsurface carrier drawn in series with each unit provided with individual power system and a unit at either end as an active drive. Once the carrier is subject to external push or pull, such push or pull is then detected by a linear forced drive detection device and signals detected are referred by a relative drive motor to generate auxiliary torque in positive direction for the positive torque to helps activate or accelerate or cater for heavy load; or to generate inverse torque to provide inverse damping for producing inverse torque to provide inverse damping function, or to produce auxiliary or damping function by manipulating a clutch from a controllable transmission gear.

(b) Description of the Prior Art

A linear drive carrier of the prior art either comprised of a manual pushcart, or a sliding board cart driven by counter force generated by feet pushing against the ground, or a boat driven by counter force created by strokes of rowing peddle (s), or a linear drive carrier comprised of two or more than two units drawn in series and pushed or pulled by manual, or a land carrier comprised of two or more than two units drawn in series with each unit having its own power system and with the unit at either end as the an active drive; or a surface or subsurface carrier comprised of two or more than two units drawn in series with each unit having its own power system and with the unit at either end as the an active drive, is found in its operation the following defectives:

1) In case of a single unit of linear driver carrier by manual, the operator could get easily exhausted particularly when carrying a heavy load, moving on an uphill, or frequent activation is involved on land, and the same exhaustion in rowing a boat up stream;

2) In case a linear drive carrier comprised of two or more than two units drawn in series by manual, putting aside the heavy mass of the carrier itself, the unit in the rear could easily smash into that in the front down the hill or in course of deceleration unless a synchronous braking system is provided; the same happens to a land carrier, or a surface or a subsurface carrier comprised of two or more than two units drawn in series with individual power system such as a motor or a engine provided to each unit and having the unit at either end to serve as the active drive.

### SUMMARY OF THE INVENTION

The primary purpose of the present invention is to provide an auxiliary or damping system to a linear forced drive carrier. To achieve the purpose, a detection device adapted to a linear forced drive is provided to detect either in one-way or two-way the direction and strength of external push or pull applied to the carrier, and to generate and transmit relative signals to motor drive control system for controlling and operating the power source of the carrier to drive the motor in the relative direction to produce auxiliary torque in the positive direction for the drive; or by manipulating the power source provided with the carrier to drive the motor to produce inverse torque for providing inverse damping function; or by manipulating a clutch or a braking device of a controllable transmission gear to provide auxiliary or damping function.

### BRIEF DESCRIPTION OF THE DRAWINGS

FIG. 1 is a block chart showing a preferred embodiment of an auxiliary or damping system of the present invention adapted to a single unit of linear forced drive carrier;

FIG. 2 is a block chart showing another preferred embodiment of an auxiliary or damping system of the present invention adapted to multiple units of linear forced drive carrier connected in series;

FIG. 3 is a schematic view showing the operation of short drive by the present invention;

FIG. 4 is a block chart of the preferred embodiment illustrated in FIG. 1 with additional interface switch operated and controlled by hand or by foot;

FIG. 5 is a block chart of the preferred embodiment illustrated in FIG. 2 with additional interface switch operated and controlled by hand or by foot;

FIG. 6 is a block chart of a power system comprised of an engine and a controllable transmission gear allowing control of full or partial function of positive/inverse rotation and speed ratio or torque; and

FIG. 7 is a block chart of a power system comprised of a motor and a controllable transmission gear allowing control of full or partial function of positive/inverse rotation and speed ratio or torque; and

FIG. 8 is a block chart showing that an independent manually operated interface mechanism and linear forced drive detection device with individual motor drive control device and an independent driving motor are provided on both sides of the present invention.

### DETAILED DESCRIPTION OF THE PREFERRED EMBODIMENTS

An auxiliary or damping system adapted to a linear forced drive carrier of the present invention is related to a detection is device of that converts mechanical displacement or force applied into electric signal. At lease one unit of the detection device is provided to where a structure to receive pull or push is located, or at where a coupling or pulling structure drawn in series between two abutted carriers in case that the system is comprised of at least two linear forced drive carriers drawn in series wherein each carrier being provided with individual power device. The detection device detects either one-way or two-way the direction and strength of the externally applied driving push or pull to produce and transmit relative signals to a motor drive control device, thus to manipulate the power source of the carrier for driving the motor so driven in relative direction and supplying auxiliary drive to the driving force; or by manipulating the power source of the carrier for the motor to produce inverse torque for providing inverse damping function; or by manipulating a clutch device or a braking damper device of a controllable transmission gear for producing auxiliary or damping function.

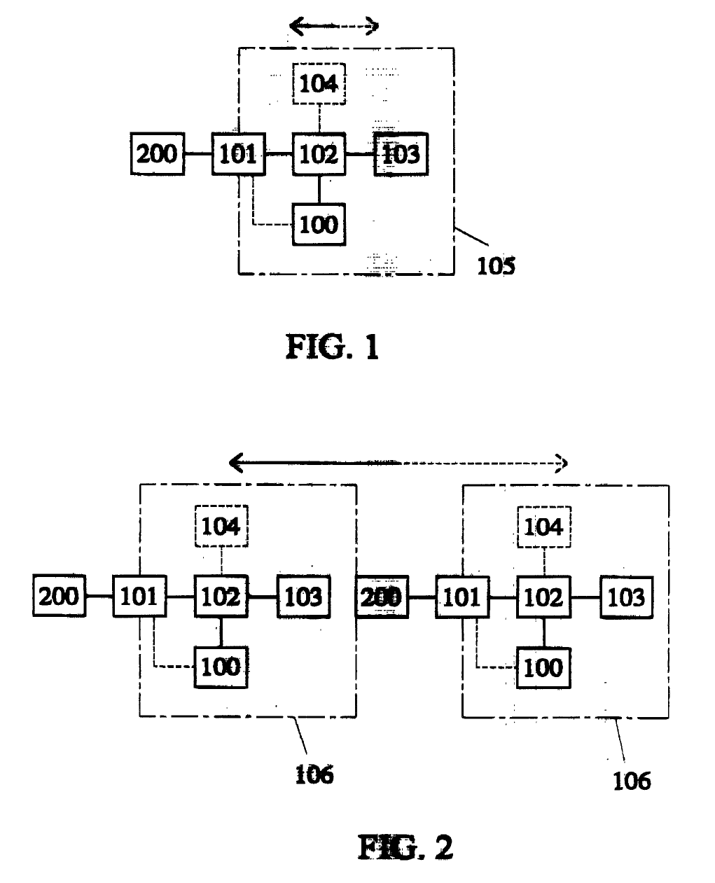

Referring to FIG. 1 for a block chart showing that an auxiliary or damping system of a preferred embodiment of the present invention is adapted to a single unit of linear forced drive carrier.

As illustrated in FIG. 2, the auxiliary or damping system is adapted to configuration comprised of multiple units of linear forced drive carrier with each provided with individual power device.

Additional to an automobile body, chassis, braking device or circuit break device activated at the same time the braking is executed and associated structures in case of a single unit of carrier; or two or more than two units of carriers drawn in series pulled or pushed by manual with each unit of carrier being provided with individual power system, the auxiliary or damping system is comprised of:

a power source 100 of the carrier: including various primary or (re)chargeable secondary batteries, or other types of (re)chargeable storage/discharging device made portable to the carrier;

a manual operation interface mechanism 200: related to at least one unit of a manual operation interface mechanism driven by linear or fractional arc displacement executed by a member or any other part of the human body, thus to apply at the same time the drawing force to the carrier and a contact or non-contact type linear forced drive detection device 101 that converts the amount of displacement or the strength of the force applied by means of photo-electric effect, voltage effect, power effect, magnetic effect, variable resistance, or any other movable mechanism;

a switch 104: an optional device, comprised of at least one manual operation interface mechanism by pressing, stepping upon, pushing, pulling or other means to control and operate a motor 103 when driven by conduction to provide short drive of a of a timed circuit braking at deferred time after the motor 103 is driven by conduction; or to manipulate the motor 103 so that when the motor 103 is driven by conduction, the timed circuit braking is executed after the inputted power is gradually decreasing during the deferred time, or to provide synchronous cut-off when coupled to a mechanical braking or to execute braking of dynamic feed back for the generator during the reduction of the motor;

a linear forced drive detection device 101: comprised of at least one unit of a contact or non-contact type of linear forced drive detection device 101 that converts mechanical displacement or strength of force applied into electric signal by means of photo-electric effect or voltage effect, power effect, magnetic effect, variable resistance, or other detection device, being provided at where the structure receiving the pull or the push is located; an optional pre-stressed or return spring may be provided to any of those detection devices;

A motor drive control device 102: including at least one unit of motor drive control device 102 comprised of electromechanical device or solid electronic device, or mix of both devices to receive signals from the linear forced drive detection device 101 for manipulating the power source 100 of the carrier to execute change of direction relatively to the motor 103, set up and select the amount of the auxiliary torque, positive or inverse, revolution speed, and limit current, or a short power drive of timed circuit breaking at deferred time for the motor 103 when driven by conduction, or a timed circuit breaking at a deferred time after the inputted power is decreasing after the motor 103 is driven by conduction; or the linear forced drive detection device 101 is provided with an auxiliary manipulation signal in relation to various outputted multi-level power in a switching mode or an invariable modulation mode to convert the direction the force is applied into electric signal as required for manipulating the separately adapted motor drive control device 102 and the motor 103, thus to produce the auxiliary push or pull in the relative mode; or to execute drive for a partial function, or as required an interface switch 104 manually controlled by hand or foot is provided to manipulate the motor drive control device 102 for supplying power to for circuit breaking relatively to the motor 103, or the interface switch 104 manually controlled by hand or foot is used to directly cut off the power or stop the output from the linear forced drive detection device 101 disregarding which working mode the linear forced drive detection device 101 maybe in, thus to execute drive control of supplying power or to cut off the power outputted from the motor drive control device 102 to the motor 103; or when the linear forced drive detection device 101 is set in any working mode, to directly operate and control the linear forced drive detection device to indicate output or to stop outputting by the operation of the interface switch 104 manipulated by hand or foot, thus to operate and control the power outputted from the motor drive control device 102 to the motor 103 for relatively driving the pulling or pushing of the carrier, e.g. wheel or tract for land carrier, propeller or peddle for surface carrier, or propeller for subsurface carrier; thus to produce the function of auxiliary drive or inverse damping of inverse torque, the function may be in the forms of both auxiliary drive in positive direction and inverse damping, or either;

a motor 103: comprised of at least one unit of AC or DC synchronous or asynchronous motor, or of AC or DC series, shunt or multiple excitation brush or brushless, synchronous or asynchronous inner or outer rotor type of motor to directly drive the pushing or pulling device of the carrier or through a transmission gear; and an optional one-way transmission gear is provided between the motor 103 and the pushing or pulling device of the carrier.

The linear forced drive carrier auxiliary or damping system is comprised of:

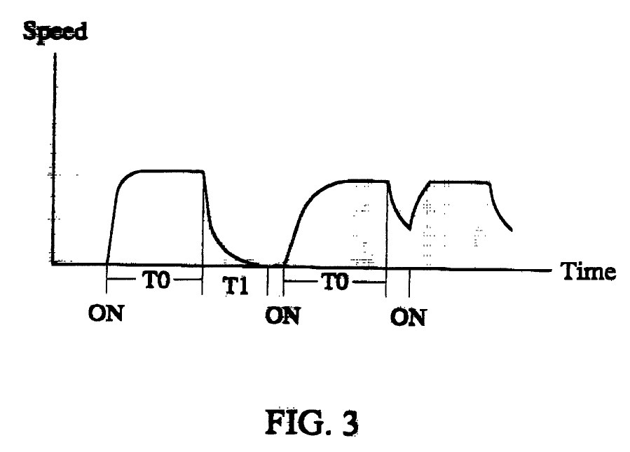

1) In case of the system is related to a single unit of linear forced drive carrier provided with a power device, and the method of manipulating its power device comprised of a motor 103, the linear forced drive detection device 101 and a motor drive control device 102 can be controlled by externally applied push or pull depending on the preset ratio, the linear forced drive detection device 101 is relatively driven to manipulate the motor drive control device 102 to drive the motor 103 to produce push or pull for the carrier or to manipulate the motor 103 for it to be given a short power drive function of a timed circuit braking at deferred time after the motor 103 is driven by conduction; or to manipulate the motor 103 so that when the motor 103 is driven by conduction, the timed circuit braking is executed after the inputted power is gradually decreasing during the deferred time. FIG. 3 shows a schematic view of the short power drive operation of the present invention. Wherein, ON relates to power supply drive; tₒ, timed drive time; t₁, time length for decreasing inputted power or gliding; the linear forced drive detection device 101 or the motor drive control device 102 is provided with a switching model of manipulation of multi-level electric power relatively outputted of various strength of power, or a model of invariable an linear regulation and control of power strength and the function to further convert the direction the force is applied into electric signal when required for the manipulation of the motor drive control device 102 and the motor 103 thus to produce an auxiliary push or pull in the relative mode; or

2) an optional interface switch 104 manipulated by hand or foot can be added to manipulate the motor drive control device 102, which further manipulates the motor 103 to be given a short power drive function of a timed circuit braking at deferred time after the motor 103 is driven by conduction; or to manipulate the motor 103 so that when the motor 103 is driven by conduction, the timed circuit braking is executed after the inputted power is gradually decreasing during the deferred time, or to regulate, control and set up the power of the drive motor 103 or to regulate its time for a deferred cut-off; or when the linear forced drive detection device 101 is set up in any given working status, to directly operate and control the source to supply power to, or to cut off the power supply to or to operate and control the linear forced drive detection device 101 to indicate output or to stop outputting by the operation of the interface switch 104 manipulated by hand or foot; thus to control and operate the power outputted from the motor drive control device 102 to the motor 103; or

3) When the system is comprised of two or more than two linear forced drive carriers 105, 106 drawn in series with each carrier provided with own power device. Wherein, one carrier serves an active and the other passive one(s) with the linear forced drive detection device 101 provided at where a structure of coupling draw or pull for series draw between two abutted carriers. The active carrier may be also provided with the linear forced drive detection device 101 subject to manual push or pull so to manipulate its inherited motor drive control device 102 and the motor 103, thus to draw the passive carrier. Alternatively, the linear forced drive detection device 101 subject to manual push or pull may not be provided to the active carrier. Instead, its inherited power device comprised of the motor drive control device 102 and the motor 103 is put under the manual control by the interface switch 104 to produce push or pull to the passive carrier. The linear forced drive detection device 101 respectively provided between two abutted carriers when subject to externally applied push or pull drives the corresponding motor control device 102 and the motor 103 so to produce auxiliary push or pull in relative direction with its force can be preset or adjusted, or to manipulate each motor 103 to provide short power drive of timed circuit breaking at deferred time when the motor 103 is driven by conduction, or to feed one short power that allows preset the time for a timed circuit braking or adjust wave form and power; or to manipulate each motor 103 to provide timed circuit breaking after the inputted electricity energy is decreasing at deferred time when the motor 103 is driven by conduction; or the linear forced drive detection device 101 is provided with an auxiliary manipulation signal in relation to various outputted multi-level power of different strength in a switching mode or an invariable modulation mode to convert the direction the force is applied into electric signal as required for manipulating the separately adapted motor drive control device 102 and the motor 103, thus to produce the auxiliary push or pull in the relative mode. Furthermore, the power device for the passive carrier comprised of the linear forced drive detection device 101, the motor drive control device 102 and the motor 103 may or may not be subject to manual control. An operational pre-stressed or a return spring may be provided to any type of the detection devices disclosed above.

Furthermore, a manually controlled interface switch 104 comprised of an operation electromechanical or solid state device and operating by hand or foot is added to the auxiliary or damping system of the linear forced drive carrier for selecting manually operated auxiliary or damping function; or for power driven in both direction and speed manipulation; or for selecting both functions of auxiliary drive or damping of inverse torque at the same time; or a short power drive of timed circuit breaking at deferred time for the motor 103 when driven by conduction, or a timed circuit breaking at a deferred time after the inputted power is decreasing after the motor 103 is driven by conduction; or the linear forced drive detection device 101 is provided with an auxiliary manipulation signal in relation to various outputted multi-level power of different strength in a switching mode or an invariable modulation mode to convert the direction the force is applied into electric signal as required for manipulating the separately adapted motor drive control device 102 and the motor 103, thus to produce the auxiliary push or pull in the relative mode; or powered function to actively supply power to drive the motor.

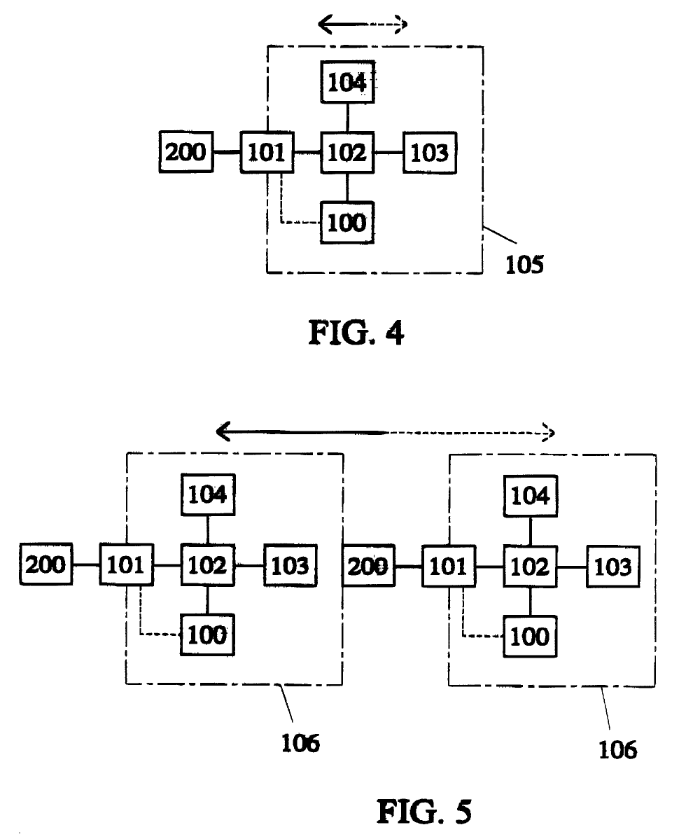

FIG. 4 shows a block chart of the preferred embodiment taken from FIG. 1 with an additional interface switch manually controlled by hand or foot.

FIG. 5 shows a block chart of the preferred embodiment taken from FIG. 2 with an additional interface switch manually controlled by hand or foot.

The auxiliary drive or damping system comprised of the structures illustrated in FIG. 4 and FIG. 5 contains one or more than one of the following functions:

1) When the carrier is subject to externally applied one-way linear push or pull, the carrier detects the applied push or pull and its direction by means of the linear forced drive detection device 101, to produce in relation of the power drive motor 103 the one-way auxiliary function of push or pull, or as required, an optional addition of the interface switch 104 manually manipulated by hand or foot is provided to manipulate the motor drive control device 102, thus to manipulate the motor 103 to relatively execute power supply or power cut-off drive control, or to provide a short power drive function of a timed circuit braking at deferred time after the motor 103 is driven by conduction; or to manipulate the motor 103 so that when the motor 103 is driven by conduction, the timed circuit braking is executed after the inputted power is gradually decreasing during the deferred time; or the linear forced drive detection device 101 or the motor drive control device 102 is provided with a switching model of manipulation of multi-level electric power relatively outputted of various strength of power, or a model of invariable an linear regulation and control of power strength and the function to further convert the direction the force is applied into electric signal when required for the manipulation of the motor drive control device 102 and the motor 103 thus to produce an auxiliary push or pull in the relative mode;

2) When the carrier is subject to externally applied two-way linear push or pull, the carrier detects the applied push or pull by means of the linear forced drive detection device 101 to output relative power for manipulating the drive motor 103 so that auxiliary drive function by manipulating the source power is available to the motor in both ways, or a bilateral damping function is produced; or as required, an optional addition of the interface switch 104 manually manipulated by hand or foot is provided to manipulate the motor drive control device 102, thus to manipulate the motor 103 to relatively execute power supply or power cut-off drive control, or to provide a short power drive function of a timed circuit braking at deferred time after the motor 103 is driven by conduction; or to manipulate the motor 103 so that when the motor 103 is driven by conduction, the timed circuit braking is executed after the inputted power is gradually decreasing during the deferred time; or the linear forced drive detection device 101 or the motor drive control device 102 is provided with a switching model of manipulation of multi-level electric power relatively outputted of various strength of power, or a model of invariable an linear regulation and control of power strength and the function to further convert the direction the force is applied into electric signal when required for the manipulation of the motor drive control device 102 and the motor 103 thus to produce an auxiliary push or pull in the relative mode;

3) In case of two-way linear push or pull, the linear forced drive detection device 101 detects the push or pull applied for manipulating the drive motor 103 with relative power, thus for the motor to produce damping function of inverse torque in either direction by manipulating the power from the inherited source of the carrier;

4) In case of a system of multiple units of linear forced drive carriers each provided with individual power device drawn in series, to relatively regulate its output direction, rpm and torque of the power device to prevent from impact for the rear carrier against the carrier in front for safety purpose;

5) The interface switch 104 manually controlled by hand or foot is used to switch for auxiliary drive, damping, auxiliary drive and damping, or power drive, or short power drive of timed circuit breaking at deferred time when the motor 103 is driven by conduction, or the linear forced drive detection device 101 or the motor drive control device 102 is provided with an auxiliary manipulation signal in relation to various outputted multi-level power of different power strength in a switching mode or of a power strength invariable modulation mode to convert the direction the force is applied into electric signal as required for manipulating the separately adapted motor drive control device 102 and the motor 103, thus to produce the auxiliary push or pull in the relative mode; and

6) A one-way controllable and adjustable damping function comprised of the interface switch 104 manually controlled by hand or foot and the linear forced drive detection device 101.

The linear forced drive detection device 101 is comprised of pressure type detection device containing relative pressure effect signal produced when subject to externally applied force; or of a linear structure directly drawn or drawn by means of multi-link mechanism when subject to externally applied force; or of a structure of variable angle detection device drawn by curved arm or multi-link mechanism that directly convert linear drive into variable drawn angular displacement; or of a structure of circulation type detection device drawn by a transmission gear that converts linear drive into circulation drive displacement; or of a structure of a detection device drawn by converting pressure into displacement through flowing force. As required, an operational pre-stressed or return spring may be provided to any type of those detection devices described above.

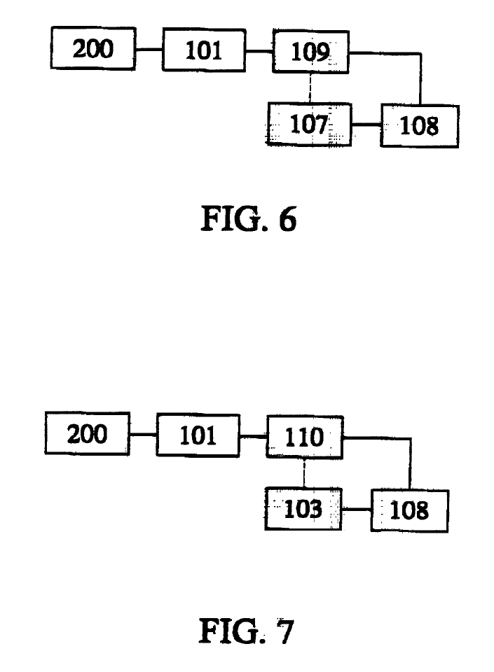

For the power device comprised of the power source 100 inherited to the carrier and the motor 103, as illustrated in FIG. 6, it may be comprised of an engine 107 and a controllable transmission gear 108 for its partial or full functions of revolution in either direction, speed ratio or torque so to relatively manipulate the engine 107 through the detection by the linear forced drive detection device 101 and the manipulation by a drive interface device 109, or to produce auxiliary drive or damping function by manipulating a clutch or braking damper of the controllable transmission gear 108. FIG. 6 shows a block chart of the power device comprised of an engine and a transmission gear with its partial or full functions of revolution in either direction, speed ratio or torque controllable. Alternatively, as illustrated in FIG. 7, the power device is comprised of the carrier power source 100 and the motor 103, or the power device can be comprised of the auxiliary motor 103 incorporated with the controllable transmission gear 108 so to relatively manipulate the auxiliary motor 103 through the manipulation of the drive interface device 110 and as detected by means of the linear forced drive detection device 101, or to manipulate the clutch or braking damper or braking device to produce auxiliary drive or damping function through detection by the linear forced drive detection device 101 and manipulation of a drive interface device 110. FIG. 7 shows a block chart of a power device comprised of a motor and a controllable transmission device with its functions of revolution in either direction, speed ratio or torque controllable.

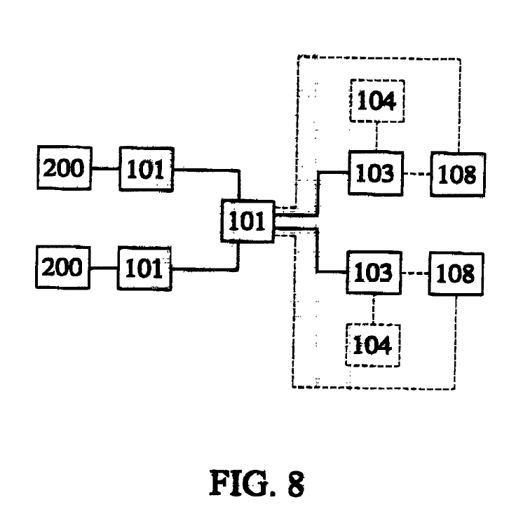

Furthermore, as the circuit block chart illustrated in FIG. 8, the auxiliary drive system of the linear forced drive carrier can be respectively provided on its both sides with independent, manual interface mechanism, linear forced drive detection device, individual motor drive control device and independent drive motor. Wherein, two or more than two motors provided on either side or both sides to receive the operation and control by a common linear forced drive detection device 101 or each by a dedicated linear forced drive detection device 101, so to control the common motor drive control device 102 or the dedicated motor drive control device 102 and further to jointly drive or independently drive those two or more than two motors 103.

The auxiliary or damping system for the linear forced drive carrier when applied to a wheelchair provided with a motor on one side or an independent motor 103 each respectively on both sides, can be of a manual interface mechanism 200 comprised of a hand wheel provided on either side or both sides of the wheelchair operating by hand to intermittently push or pull the hand wheel while simultaneously drive and manipulate the adapted linear forced drive detection device 101 to respectively manipulate the dedicated motor drive control device 102, or to jointly manipulate a common motor drive control device 102, and further to jointly drive the motor 103 on either side or each dedicated motor 103 independently provided on both sides to produce auxiliary push or pull in relative direction that can be preset or adjusted for its force; or to manipulate each motor 103 to provide short power drive of timed circuit breaking at deferred time when the motor 103 is driven by conduction, or to manipulate each motor 103 to provide timed circuit breaking after the inputted electricity energy is decreasing at deferred time when the motor 103 is driven by conduction; or to feed one short power that allows preset the time for a timed circuit braking or adjust wave form and power.

If the operational switch 104 is used as the manual control interface mechanism 200, the motor 103 can be also provided on either side or each on both sides of the wheelchair, and the switch 104 is provided on either side or each on both sides of the wheelchair to jointly drive the motor 103 on either side or each motor 103 independently provided on each side of the wheelchair to produce auxiliary push or pull in relative direction that can be preset or adjusted for its force; or to manipulate each motor 103 to provide short power drive of timed circuit breaking at deferred time when the motor 103 is driven by conduction, or to manipulate each motor 103 to provide timed circuit breaking after the inputted electricity energy is decreasing at deferred time when the motor 103 is driven by conduction; or to feed one short power that allows preset the time for a timed circuit braking or adjust wave form and power.

As disclosed above, the auxiliary or damping system of the linear forced drive carrier of the present invention by providing a certain carrier subject to externally applied linear push or pull for its power motor to drive the motor to produce auxiliary drive when the carrier is subject to push or pull and such push or pull is detected by the linear forced drive detection device to help the carrier starting up in case of up hill, acceleration, head wind, up the stream, heavy load, short power drive of timed circuit breaking at deferred time when the motor 103 is driven by conduction, or to manipulate each motor 103 to provide timed circuit breaking after the inputted electricity energy is decreasing at deferred time when the motor 103 is driven by conduction; or the linear forced drive detection device 101 is provided with an auxiliary manipulation signal in relation to various outputted multi-level power in a switching mode or an invariable modulation mode to convert the direction the force is applied into electric signal as required for manipulating the separately adapted motor drive control device 102 and the motor 103, thus to produce the auxiliary push or pull in the relative mode; and producing damping for relative adjustment and control of the outputted direction, rpm and torque of the power system when a single unit of carrier or multiple units of carriers drawn in series and having each unit provided with individual power device is deceleration to prevent impacts from the carrier in rear for safety purpose, is innovative with precise function. Therefore, this application is duly filed accordingly.

1. An auxiliary or damping system adapted to a linear forced drive carrier of the present invention is related to a detection device of that converts mechanical displacement or force applied into electric signal; at lease one unit of the detection device is provided to where a structure to receive pull or push is located, or at where a coupling or pulling structure drawn in series between two abutted carriers in case that the system is comprised of at least two linear forced drive carriers drawn in series wherein each carrier being provided with individual power device; the detection device detects either one-way or two-way the direction and strength of the externally applied driving push or pull to produce and transmit relative signals to a motor drive control device, thus to manipulate the power source of the carrier for driving the motor so driven in relative direction and supplying auxiliary drive to the driving force; or by manipulating the power source of the carrier for the motor to produce inverse torque for providing inverse damping function; or by manipulating a clutch device or a braking damper device of a controllable transmission gear for producing auxiliary or damping function;
Additional to an automobile body, chassis, braking device or circuit break device activated at the same time the braking is executed and associated structures in case of a single unit of carrier; or two or more than two units of carriers drawn in series pulled or pushed by manual with each unit of carrier being provided with individual power system, the auxiliary or damping system is comprised of:
a power source 100 of the carrier: including various primary or (re) chargeable secondary batteries, or other types of (re)chargeable storage/discharging device made portable to the carrier;
a manual operation interface mechanism 200: related to at least one unit of a manual operation interface mechanism driven by linear or fractional arc displacement executed by a member or any other part of the human body, thus to apply at the same time the drawing force to the carrier and a contact or non-contact type linear forced drive detection device 101 that converts the amount of displacement or the strength of the force applied by means of photo-electric effect, voltage effect, power effect, magnetic effect, variable resistance, or any other movable mechanism;
a switch 104: an optional device, comprised of at least one manual operation interface mechanism by pressing, stepping upon, pushing, pulling or other means to control and operate a motor 103 when driven by conduction to provide short drive of a of a timed circuit braking at deferred time after the motor 103 is driven by conduction; or to manipulate the motor 103 so that when the motor 103 is driven by conduction, the timed circuit braking is executed after the inputted power is gradually decreasing during the deferred time, or to provide synchronous cut-off when coupled to a mechanical braking or to execute braking of dynamic feed back for the generator during the reduction of the motor;
a linear forced drive detection device 101: comprised of at least one unit of a contact or non-contact type of linear forced drive detection device 101 that converts mechanical displacement or strength of force applied into electric signal by means of photo-electric effect or voltage effect, power effect, magnetic effect, variable resistance, or other detection device, being provided at where the structure receiving the pull or the push is located; an optional pre-stressed or return spring may be provided to any of those detection devices;
A motor drive control device 102: including at least one unit of motor drive control device 102 comprised of electro-mechanical device or solid electronic device, or mix of both devices to receive signals from the linear forced drive detection device 101 for manipulating the power source 100 of the carrier to execute change of direction relatively to the motor 103, setup and select the amount of the auxiliary torque, positive or inverse, revolution speed, and limit current, or a short power drive of timed circuit breaking at deferred time for the motor 103 when driven by conduction, or a timed circuit breaking at a deferred time after the inputted power is decreasing after the motor 103 is driven by conduction; or the linear forced drive detection device 101 is provided with an auxiliary manipulation signal in relation to various outputted multi-level power in a switching mode or an invariable modulation mode to convert the direction the force is applied into electric signal as required for manipulating the separately adapted motor drive control device 102 and the motor 103, thus to produce the auxiliary push or pull in the relative mode; or to execute drive for a partial function, or as required an interface switch 104 manually controlled by hand or foot is provided to manipulate the motor drive control device 102 for supplying power to for circuit breaking relatively to the motor 103, or the interface switch 104 manually controlled by hand or foot is used to directly cut off the power or stop the output from the linear forced drive detection device 101 disregarding which working mode the linear forced drive detection device 101 may be in, thus to execute drive control of supplying power or to cut off the power outputted from the motor drive control device 102 to the motor 103; or when the linear forced drive detection device 101 is set in any working mode, to directly operate and control the linear forced drive detection device to indicate output or to stop outputting by the operation of the interface switch 104 manipulated by hand or foot, thus to operate and control the power outputted from the motor drive control device 102 to the motor 103 for relatively driving the pulling or pushing of the carrier, e.g. wheel or tract for land carrier, propeller or peddle for surface carrier, or propeller for subsurface carrier; thus to produce the function of auxiliary drive or inverse damping of inverse torque, the function may be in the forms of both auxiliary drive in positive direction and inverse damping, or either;
a motor 103: comprised of at least one unit of AC or DC synchronous or asynchronous motor, or of AC or DC series, shunt or multiple excitation brush or brushless, synchronous or asynchronous inner or outer rotor type of motor to directly drive the pushing or pulling device of the carrier or through a transmission gear; and an optional one-way transmission gear is provided between the motor 103 and the pushing or pulling device of the carrier;
The linear forced drive carrier auxiliary or damping system is comprised of:
1) In case of the system is related to a single unit of linear forced drive carrier provided with a power device, and the method of manipulating its power device comprised of a motor 103, the linear forced drive detection device 101 and a motor drive control device 102 can be controlled by externally applied push or pull depending on the preset ratio, the linear forced drive detection device 101 is relatively driven to manipulate the motor drive control device 102 to drive the motor 103 to produce push or pull for the carrier or to manipulate the motor 103 for it to be given a short power drive function of a timed circuit braking at deferred time after the motor 103 is driven by conduction; or to manipulate the motor 103 so that when the motor 103 is driven by conduction, the timed circuit braking is executed after the inputted power is gradually decreasing during the deferred time; the linear forced drive detection device 101 or the motor drive control device 102 is provided with a switching model of manipulation of multi-level electric power relatively outputted of various strength of power, or a model of invariable an linear regulation and control of power strength and the function to further convert the direction the force is applied into electric signal when required for the manipulation of the motor drive control device 102 and the motor 103 thus to produce an auxiliary push or pull in the relative mode; or
2) an optional interface switch 104 manipulated by hand or foot can be added to manipulate the motor drive control device 102, which further manipulates the motor 103 to be given a short power drive function of a timed circuit braking at deferred time after the motor 103 is driven by conduction; or to manipulate the motor 103 so that when the motor 103 is driven by conduction, the timed circuit braking is executed after the inputted power is gradually decreasing during the deferred time, or to regulate, control and set up the power of the drive motor 103 or to regulate its time for a deferred cut-off; or when the linear forced drive detection device 101 is set up in any given working status, to directly operate and control the source to supply power to, or to cut off the power supply to or to operate and control the linear forced drive detection device 101 to indicate output or to stop outputting by the operation of the interface switch 104 manipulated by hand or foot; thus to control and operate the power outputted from the motor drive control device 102 to the motor 103; or
3) When the system is comprised of two or more than two linear forced drive carriers 105, 106 drawn in series with each carrier provided with own power device. Wherein, one carrier serves an active and the other passive one(s) with the linear forced drive detection device 101 provided at where a structure of coupling draw or pull for series draw between two abutted carriers; the active carrier may be also provided with the linear forced drive detection device 101 subject to manual push or pull so to manipulate its inherited motor drive control device 102 and the motor 103, thus to draw the passive carrier; alternatively, the linear forced drive detection device 101 subject to manual push or pull may not be provided to the active carrier; instead, its inherited power device comprised of the motor drive control device 102 and the motor 103 is put under the manual control by the interface switch 104 to produce push or pull to the passive carrier; the linear forced drive detection device 101 respectively provided between two abutted carriers when subject to externally applied push or pull drives the corresponding motor control device 102 and the motor 103 so to produce auxiliary push or pull in relative direction with its force can be preset or adjusted, or to manipulate each motor 103 to provide short power drive of timed circuit breaking at deferred time when the motor 103 is driven by conduction, or to feed one short power that allows preset the time for a timed circuit braking or adjust wave form and power; or to manipulate each motor 103 to provide timed circuit breaking after the inputted electricity energy is decreasing at deferred time when the motor 103 is driven by conduction; or the linear forced drive detection device 101 is provided with an auxiliary manipulation signal in relation to various outputted multi-level power of different strength in a switching mode or an invariable modulation mode to convert the direction the force is applied into electric signal as required for manipulating the separately adapted motor drive control device 102 and the motor 103, thus to produce the auxiliary push or pull in the relative mode; and the power device for the passive carrier comprised of the linear forced drive detection device 101, the motor drive control device 102 and the motor 103 may or may not be subject to manual control.

2. An auxiliary or damping system adapted to a linear forced drive carrier as claimed in claim 1, wherein, a manually controlled interface switch 104 comprised of an operation electromechanical or solid state device and operating by hand or foot is added to the auxiliary or damping system of the linear forced drive carrier for selecting manually operated auxiliary or damping function, or for power driven in both direction and speed manipulation; or for selecting both functions of auxiliary drive or damping of inverse torque at the same time; or a short power drive of timed circuit breaking at deferred time for the motor 103 when driven by conduction, or a timed circuit breaking at a deferred time after the inputted power is decreasing after the motor 103 is driven by conduction; or the linear forced drive detection device 101 is provided with an auxiliary manipulation signal in relation to various outputted multi-level power of different strength in a switching mode or an invariable modulation mode to convert the direction the force is applied into electric signal as required for manipulating the separately adapted motor drive control device 102 and the motor 103, thus to produce the auxiliary push or pull in the relative mode; or powered function to actively supply power to drive the motor.

3. An auxiliary or damping system adapted to a linear forced drive carrier as claimed in claim 1 or 2, wherein, the system contains one or more than one of the following functions:
1) When the carrier is subject to externally applied one-way linear push or pull, the carrier detects the applied push or pull and its direction by means of the linear forced drive detection device 101, to produce in relation of the power drive motor 103 the one-way auxiliary function of push or pull, or as required, an optional addition of the interface switch 104 manually manipulated by hand or foot is provided to manipulate the motor drive control device 102, thus to manipulate the motor 103 to relatively execute power supply or power cut-off drive control, or to provide a short power drive function of a timed circuit braking at deferred time after the motor 103 is driven by conduction; or to manipulate the motor 103 so that when the motor 103 is driven by conduction, the timed circuit braking is executed after the inputted power is gradually decreasing during the deferred time; or the linear forced drive detection device 101 or the motor drive control device 102 is provided with a switching model of manipulation of multi-level electric power relatively outputted of various strength of power, or a model of invariable an linear regulation and control of power strength and the function to further convert the direction the force is applied into electric signal when required for the manipulation of the motor drive control device 102 and the motor 103 thus to produce an auxiliary push or pull in the relative mode;
2) When the carrier is subject to externally applied two-way linear push or pull, the carrier detects the applied push or pull by means of the linear forced drive detection device 101 to output relative power for manipulating the drive motor 103 so that auxiliary drive function by manipulating the source power is available to the motor in both ways, or a bilateral damping function is produced; or as required, an optional addition of the interface switch 104 manually manipulated by hand or foot is provided to manipulate the motor drive control device 102, thus to manipulate the motor 103 to relatively execute power supply or power cut-off drive control, or to provide a short power drive function of a timed circuit braking at deferred time after the motor 103 is driven by conduction; or to manipulate the motor 103 so that when the motor 103 is driven by conduction, the timed circuit braking is executed after the inputted power is gradually decreasing during the deferred time; or the linear forced drive detection device 101 or the motor drive control device 102 is provided with a switching model of manipulation of multi-level electric power relatively outputted of various strength of power, or a model of invariable an linear regulation and control of power strength and the function to further convert the direction the force is applied into electric signal when required for the manipulation of the motor drive control device 102 and the motor 103 thus to produce an auxiliary push or pull in the relative mode;
3) In case of two-way linear push or pull, the linear forced drive detection device 101 detects the push or pull applied for manipulating the drive motor 103 with relative power, thus for the motor to produce damping function of inverse torque in either direction by manipulating the power from the carrier-laden source;
4) In case of a system of multiple units of linear forced drive carriers each provided with individual power device drawn in series, to relatively regulate its output direction, rpm and torque of the power device to prevent from impact for the rear carrier against the carrier in front for safety purpose;
5) The interface switch 104 manually controlled by hand or foot is used to switch for auxiliary drive, damping, auxiliary drive and damping, or power drive, or short power drive of timed circuit breaking at deferred time when the motor 103 is driven by conduction, or the linear forced drive detection device 101 or the motor drive control device 102 is provided with an auxiliary manipulation signal in relation to various outputted multi-level power of different power strength in a switching mode or of a power strength invariable modulation mode to convert the direction the force is applied into electric signal as required for manipulating the separately adapted motor drive control device 102 and the motor 103, thus to produce the auxiliary push or pull in the relative mode; and
6) A one-way controllable and adjustable damping function comprised of the interface switch 104 manually controlled by hand or foot and the linear forced drive detection device 101.

4. An auxiliary or damping system adapted to a linear forced drive carrier as claimed in claim 1 or 2, wherein, the linear forced drive detection device 101 is comprised of pressure type detection device containing relative pressure effect signal produced when subject to externally applied force; or of a linear structure directly drawn or drawn by means of multi-link mechanism when subject to externally applied force; or of a structure of variable angle detection device drawn by curved arm or multi-link mechanism that directly convert linear drive into variable drawn angular displacement; or of a structure of circulation type detection device drawn by a transmission gear that converts linear drive into circulation drive displacement; or of a structure of a detection device drawn by converting pressure into displacement through flowing force; as required, an operational pre-stressed or return spring may be provided to any type of those detection devices described above.

5. An auxiliary or damping system adapted to a linear forced drive carrier as claimed in claim 1 or 2, wherein, the power device comprised of the power source 100 of the carrier and the motor 103 provides by means of an engine 107 and a controllable transmission gear 108 its partial or full functions of revolution in either direction, speed ratio or torque so to relatively manipulate the engine 107 through the detection by the linear forced drive detection device 101 and the manipulation by a drive interface device 109, or to produce auxiliary drive or damping function by manipulating a clutch or braking damper of the controllable transmission gear 108.

6. An auxiliary or damping system adapted to a linear forced drive carrier as claimed in claim 1 or 2, wherein, the power device comprised of the carrier power source 100 and the motor 103, is comprised of the auxiliary motor 103 incorporated with the controllable transmission gear 108 so to relatively manipulate the auxiliary motor 103 through the manipulation of the drive interface device 110 and as detected by means of the linear forced drive detection device 101, or to manipulate the clutch or braking damper or braking device to produce auxiliary drive or damping function through detection by the linear forced drive detection device 101 and manipulation of a drive interface device 110.

7. An auxiliary or damping system adapted to a linear forced drive carrier as claimed in claim 1, wherein, two or more than two motors provided on either side or both sides to receive the operation and control by a common linear forced drive detection device 101 or each by a dedicated linear forced drive detection device 101, so to control the common motor drive control device 102 or the dedicated motor drive control device 102 and further to jointly drive or independently drive those two or more than two motors 103.

8. An auxiliary or damping system adapted to a linear forced drive carrier as claimed in claim 1, wherein, the auxiliary or damping system for the linear forced drive carrier when applied to a wheelchair provided with a motor on one side or an independent motor 103 each respectively on both sides, is a manual interface mechanism 200 comprised of a hand wheel provided on either side or both sides of the wheelchair operating by hand to intermittently push or pull the hand wheel while simultaneously drive and manipulate the adapted linear forced drive detection device 101 to respectively manipulate the dedicated motor drive control device 102, or to jointly manipulate a common motor drive control device 102, and further to jointly drive the motor 103 on either side or each dedicated motor 103 independently provided on both sides to produce auxiliary push or pull in relative direction that can be preset or adjusted for its force; or to manipulate each motor 103 to provide short power drive of timed circuit breaking at deferred time when the motor 103 is driven by conduction, or to manipulate each motor 103 to provide timed circuit breaking after the inputted electricity energy is decreasing at deferred time when the motor 103 is driven by conduction; or to feed one short power that allows preset the time for a timed circuit braking or adjust wave form and power.

9. An auxiliary or damping system adapted to a linear forced drive carrier as claimed in claim 1, wherein, the operational switch 104 is used as the manual control interface mechanism 200, the motor 103 can be also provided on either side or each on both sides of the wheelchair, and the switch 104 is provided on either side or each on both sides of the wheelchair to jointly drive the motor 103 on either side or each motor 103 independently provided on each side of the wheelchair to produce auxiliary push or pull in relative direction that can be preset or adjusted for its force; or to manipulate each motor 103 to provide short power drive of timed circuit breaking at deferred time when the motor 103 is driven by conduction, or to manipulate each motor 103 to provide timed circuit breaking after the inputted electricity energy is decreasing at deferred time when the motor 103 is driven by conduction; or to feed one short power that allows preset the time for a timed circuit braking or adjust wave form and power.
